(19) United States
(12) Patent Application Publication
(10) Pub. No.: US 2022/0111379 A1
(43) Pub. Date: Apr. 14, 2022

(54) REACTION TUBE FOR MULTIPLE NUCLEIC ACID AMPLIFICATION

(71) Applicant: ACADEMY OF MILITARY MEDICAL SCIENCES, Beijing 100039 (CN)

(72) Inventors: Shengqi WANG, Beijing (CN); Zhen RONG, Beijing (CN); Rui XIAO, Beijing (CN); Feng WANG, Beijing (CN)

(21) Appl. No.: 17/418,947

(22) PCT Filed: Dec. 30, 2019
(86) PCT No.: PCT/CN2019/129968

§ 371 Date: Jun. 28, 2021

(30) Foreign Application Priority Data
Dec. 29, 2018 (CN) 201811647409.7

(51) Int. Cl. B01L 3/00

(52) U.S. Cl. CPC B01L 3/50851; B01L 2300/043; B01L 2300/12; B01L 2200/0689; B01L 2300/0832; B01L 2400/0677; B01L 2300/0829

(57) ABSTRACT

A reaction tube for multiple nucleic acid amplification, related to the applied technical field of biological science research and medical tests. The reaction tube for multiple nucleic acid amplification comprises a base (1) and multiple reaction tube cavities (3). The base (1) is provided with a reference plane (2). Openings of the multiple reaction cavities (3) are provided on the reference plane (2). The cavities are perpendicular to the reference plane (2) and extended towards the interior of the base (1). The reaction tube for multiple nucleic acid amplification provides the multiple reaction tube cavities (3) on the reference plane (2) of the base (1).

### CROSS-REFERENCE TO RELATED APPLICATION

The present disclosure claims the priority to the Chinese patent application filed on Dec. 29, 2018 with the Chinese Patent Office with the filing No. 201811647409.7, and entitled “Reaction Tube for Multiple Nucleic Acid Amplification”, the contents of which are incorporated herein by reference in entirety.

### TECHNICAL FIELD

The present disclosure relates to the application technical fields such as biological science research and medical examination, in particular, to a reaction tube capable of performing multiple nucleic acid amplification.

### BACKGROUND ART

Polymerase chain reaction (PCR) technology is a technology for rapid amplification of DNA in vitro, and each cycle includes three processes of denaturation, annealing, and extension. First, a double-stranded DNA sample is heated at a high temperature of about 95° C., and a hydrogen bond between the double strands will break, so that the DNA is thermally decomposed into two complementary single-stranded DNA molecules, which process is called as a high temperature melting reaction; then, the temperature is rapidly decreased to a range of about 50-65° C., and under this temperature, the single-stranded DNA is combined with a primer according to the principle of base complementary pairing, which process is called as a low-temperature annealing reaction; after the annealing reaction is finished, the temperature should be rapidly raised to about 72° C. to perform an extension reaction, and under condition of DNA polymerase and appropriate magnesium ion concentration, a mononucleotide is bound from 3′ end of the primer, so as to form a new DNA. Through such a process, one original DNA double-stranded molecule is formed into two DNA molecules, the number of which is doubled. After each cycle, the number of target nucleic acid molecules is doubled, and these newly formed double strands may be used as a template for next cycle. After 30-40 cycles, the number of target nucleic acid molecules is amplified to approximately 109 times the original number.

Hence, PCR, also referred to as cell-free molecular cloning or specific DNA sequence in vitro primer-directed enzymatic amplification technology, enables the target DNA to be rapidly amplified, and has the characteristics such as strong specificity, high sensitivity, simple operation, and high efficiency, and it can be used not only for basic studies such as gene separation, cloning, and nucleic acid sequence analysis, but also for any aspects containing DNA and RNA such as disease diagnosis.

In addition, isothermal amplification is also a new method for nucleic acid amplification, and has received more and more attention in recent years.

However, irrespective of the PCR amplification technology or the isothermal amplification technology, there are still many defects in simultaneous amplification reaction for multiple nucleic acid.

### SUMMARY

Objectives of the present disclosure include providing a reaction tube capable of performing multiple nucleic acid amplification so as to solve one of the technical problems existing in the nucleic acid amplification reaction tubes in the prior art.

In order to achieve at least one of the above objectives, the present disclosure adopts the following technical solutions.

A reaction tube capable of performing multiple nucleic acid amplification provided in the present disclosure includes a base and a plurality of reaction tube cavities, wherein the base is provided with a reference plane, openings of the plurality of reaction tube cavities are all provided on the reference plane, and inner cavities of the plurality of reaction tube cavities all extend towards the interior of the base, perpendicularly to the reference plane.

On the basis of the above technical solution, further, the plurality of reaction tube cavities are arranged in a circle around a same axis.

The technical effects of this technical solution lie in that the plurality of reaction tube cavities distributed (arranged) in a circle, on one hand, are relatively compact in structure, and on the other hand, are more regular in layout, which facilitates operations of injecting and extracting test samples in the test. For example, eight, twelve or sixteen reaction tube cavities are distributed in a circle around a same central axis.

On the basis of any one of the above technical solutions, further, the plurality of reaction tube cavities are arranged around a same axis to form multiple circles having different radii.

The technical effects of this technical solution lie in that this structure can distribute the plurality of reaction tube cavities along multiple rings coaxially but having different radii, then as many reaction tube cavities as possible are provided in a smaller space. For example, twelve reaction tube cavities provided on an outer ring, and six reaction tube cavities provided on an inner ring, which are uniformly arranged around the same central axis.

On the basis of any one of the above technical solutions, further, the plurality of reaction tube cavities located in a same ring are separately fixed to the base, respectively.

The technical effects of this technical solution lie in that respective reaction tube cavities provided independently save the material of the whole reaction tube, and reduce the weight of the reaction tube. Meanwhile, as being independently provided, the plurality of reaction tube cavities are easily distinguished and arranged in appearance, facilitating the operation of the test and improving the detection efficiency.

Alternatively, the plurality of reaction tube cavities located in a same ring are integrally molded and fixed to the base.

The technical effects of this technical solution lie in that integrally molding all the reaction tube cavities on the base helps to uniformly heat all the reaction tube cavities and achieve an isothermal effect, and the whole reaction tube is more compact in structure and more complete in appearance.

On the basis of any one of the above technical solutions, further, a central tube cavity is further included; and the central tube cavity is provided on the reference plane and is located at a ring center of the plurality of reaction tube cavities.

The technical effects of this technical solution lie in that the central tube cavity not only can reduce weight of a reaction tube body, but also can utilize the central tube cavity as an operation space to perform an amplification reaction operation through an operation handle cooperating with the central tube cavity.

On the basis of any one of the above technical solutions, further, the central tube cavity penetrates through the base.

The technical effects of this technical solution lie in that the central tube cavity penetrating through the base further reduces the mass of the reaction tube, and also provides a sufficient space for the test operation.

On the basis of any one of the above technical solutions, further, the base is in a cylindrical shape, and an axis of the base coincides with an axis of the central tube cavity.

The technical effects of this technical solution lie in that the base in a cylindrical shape is convenient to be provided with a screw cover, and by using a structure in screw-thread fit with a side wall of the screw cover, unified blocking of all the reaction tube cavities by the screw cover is realized.

On the basis of any one of the above technical solutions, further, a blocking member or a screw cover is further included; the blocking member is provided at an opening of any one of the reaction tube cavities; and the screw cover is spirally provided at one end of the base, blocking the openings of the plurality of reaction tube cavities.

The technical effects of this technical solution lie in that the blocking member is provided at an opening of the reaction tube cavity, preferably a heat sealing film or a heat sealant is adopted to realize sealing, the screw cover blocks all the reaction tube cavities integrally, temporarily seals the nucleic acid sample solution in the reaction tube cavities, prevents the nucleic acid sample solution against factors such as external dust and light, and may also prevent the nucleic acid sample solution from being poured out and flowing out. In addition, in order to facilitate injecting the nucleic acid sample solution, an injection hole may be provided in the screw cover.

On the basis of any one of the above technical solutions, further, the plurality of reaction tube cavities are distributed in rows and columns on the reference plane.

The technical effects of this technical solution lie in that the reaction tube cavities distributed in rows and columns are more regular in structure and positioned more accurately. In this case, a heat sealing film or a heat sealant may be adopted to seal the reaction tube cavities.

The present disclosure includes, for example, following benefit effects.

Regarding the reaction tube capable of performing multiple nucleic acid amplification provided in the present disclosure, a plurality of reaction tube cavities are provided on the reference plane of the base, a nucleic acid sample and various PCR systems can be added for performing multiple PCR amplification, or the tube cavities contain a PCR freeze-drying system, one kind of nucleic acid sample is allocated as required to different reaction tube cavities to realize amplification. It is also possible to amplify a plurality of different nucleic acids simultaneously, and retain or perform other reaction tests in the same reaction environment, thus greatly improving the nucleic acid amplification efficiency, and ensuring the uniformity of conditions for the nucleic acid amplification.

Additional technical features of the present disclosure and advantages thereof will be illustrated more apparently in the following description, or may be comprehended through specific practice of the present disclosure.

### BRIEF DESCRIPTION OF DRAWINGS

In order to more clearly illustrate technical solutions of embodiments of the present disclosure, accompanying drawings which need to be used in the description of the embodiments will be introduced below briefly. Apparently, the accompanying drawings in the following description are for some embodiments of the present disclosure, and a person ordinarily skilled in the art still could obtain other relevant drawings according to these drawings, without using any creative efforts.

FIG. 1 is a perspective structural view of outline of a first reaction tube capable of performing multiple nucleic acid amplification provided in an example of the present disclosure;

FIG. 2 is a front view of FIG. 1;

FIG. 3 is a top view of FIG. 2;

FIG. 4 is a perspective structural view of outline of a second reaction tube capable of performing multiple nucleic acid amplification provided in an example of the present disclosure;

FIG. 5 is a front view of FIG. 4;

FIG. 6 is a top view of FIG. 5;

FIG. 7 is a perspective structural view of outline of a third reaction tube capable of performing multiple nucleic acid amplification provided in an example of the present disclosure;

FIG. 8 is a top view of FIG. 7;

FIG. 9 is a perspective structural view of outline of a fourth reaction tube capable of performing multiple nucleic acid amplification provided in an example of the present disclosure;

FIG. 10 is a front view of FIG. 9;

FIG. 11 is a top view of FIG. 10;

FIG. 12 is a chart of agarose gel electrophoresis result of integrated multiple tube type PCR amplification; and

FIG. 13 is a chart of agarose gel electrophoresis result of integrated PCR amplification.

Reference signs: 1—base; 2—reference plane; 3—reaction tube cavity; 4—central tube cavity.

### DETAILED DESCRIPTION OF EMBODIMENTS

Technical solutions of the present disclosure will be described clearly and completely below in combination with accompanying drawings, and apparently, the examples described are only a part of examples of the present disclosure, rather than all examples. Based on the examples in the present disclosure, all of other examples obtained by a person ordinarily skilled in the art without using any creative efforts shall fall within the scope of protection of the present disclosure.

In the description of the present disclosure, it should be indicated that orientation or positional relationships indicated by terms “center”, “upper”, “lower”, “left”, “right”, “vertical”, “horizontal”, “inner”, “outer” and so on are based on orientation or positional relationships as shown in the accompanying drawings, merely for facilitating describing the present disclosure and simplifying the description, rather than indicating or suggesting that related devices or elements have to be in the specific orientation or configured and operated in a specific orientation, therefore, they should not be construed as limiting the present disclosure. Besides, terms “first”, “second”, and “third” are merely for descriptive purpose, but should not be construed as indicating or implying importance in the relativity.

In the description of the present disclosure, it should be noted that unless otherwise specified and defined clearly, terms “mount”, “join”, and “connect” should be understood in a broad sense, for example, a connection can be a fixed connection, a detachable connection, or an integrated connection; it can be a mechanical connection or an electrical connection; it can be a direct connection or an indirect connection through an intermediate medium, and it also can be an inner communication between two elements. For a person ordinarily skilled in the art, specific meanings of the above-mentioned terms in the present disclosure could be understood according to specific circumstances.

### I. Description of Prior Art

Whether it is PCR amplification technique or isothermal amplification technique, when the amplification reaction is performed simultaneously on multiple nucleic acids, due to the design defect of a reaction device, there is inevitably inconsistency in reaction environment conditions and operation time, and then there occurs the situation that an amplification effect of reaction performed first and an amplification effect of reaction performed subsequently are quite different. However, when a conventional PCR tube performs multiple PCR, an amplification system tends to have cross interference, affecting the amplification effect.

### II. Summary of Technical Solution of the Present Disclosure

The reaction tube capable of performing multiple nucleic acid amplification provided in the present disclosure includes a base 1 and a plurality of reaction tube cavities 3; the base 1 is provided with a reference plane 2, openings of the plurality of reaction tube cavities 3 are all provided on the reference plane 2, and inner cavities of the plurality of reaction tube cavities all extend towards the interior of the base 1, perpendicularly to the reference plane 2.

The above technical solution of the reaction tube capable of performing multiple nucleic acid amplification can well solve the problems such as unconcentrated and non-uniform operations, inconsistent reaction conditions, cross interference, and low amplification efficiency in the multiple nucleic acid amplification existing in the nucleic acid amplification reaction tubes in the prior art. A plurality of reaction tube cavities 3 are provided on the reference plane 2 of the base 1, a nucleic acid sample and various PCR systems can be added for performing multiple PCR amplification, or the tube cavities contain a PCR freeze-drying system, one kind of nucleic acid sample is allocated as required to different reaction tube cavities 3 to realize amplification. It is also possible to amplify a plurality of different nucleic acids simultaneously, and retain or perform other reaction tests in the same reaction environment, thus greatly improving the nucleic acid amplification efficiency, and ensuring the uniformity of conditions for the nucleic acid amplification.

### III. Specific Embodiments of the Technical Solution of the Present Disclosure

Regarding the technical problems existing in the prior technical solution above, the technical solution of the present disclosure is further explained and described below in combination with specific embodiments.

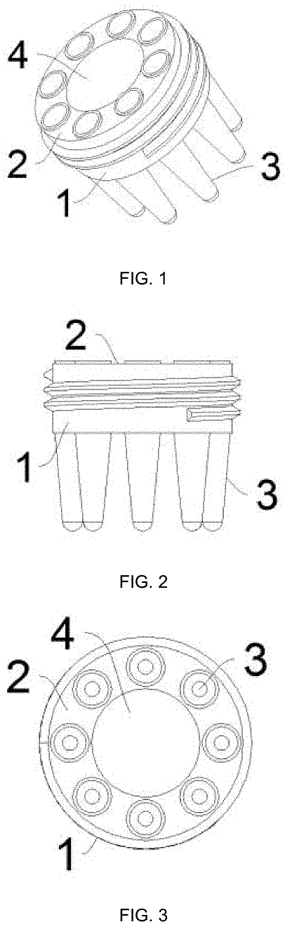

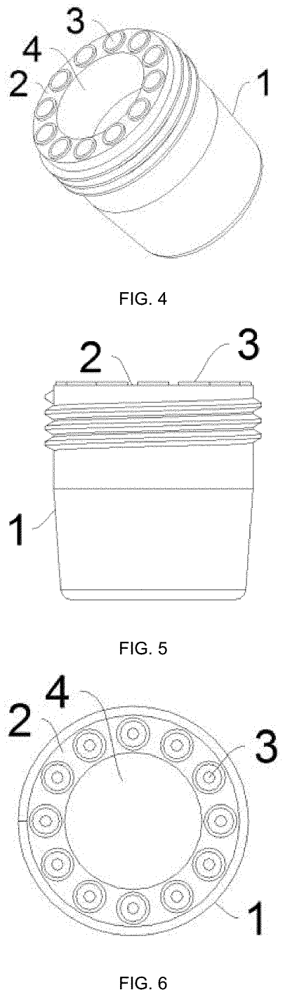

The present example provides a reaction tube capable of performing multiple nucleic acid amplification, wherein FIG. 1 is a perspective structural view of outline of a first reaction tube capable of performing multiple nucleic acid amplification provided in an example of the present disclosure; FIG. 2 is a front view of FIG. 1; FIG. 3 is a top view of FIG. 2; FIG. 4 is a perspective structural view of outline of a second reaction tube capable of performing multiple nucleic acid amplification provided in an embodiment of the present disclosure; FIG. 5 is a front view of FIG. 4; and FIG. 6 is a top view of FIG. 5. As shown in FIGS. 1-6, the reaction tube capable of performing multiple nucleic acid amplification includes a base 1 and a plurality of reaction tube cavities 3 provided on the base 1; the base 1 is provided with a reference plane 2, openings of the plurality of reaction tube cavities 3 are all provided on the reference plane 2, and inner cavities of the plurality of reaction tube cavities all extend towards the interior of the base 1, perpendicularly to the reference plane 2.

On the basis of the above example, further, as shown in FIGS. 1, 3, 4, and 6, the plurality of reaction tube cavities 3 are distributed in a circle around the same axis in the same radius. In this case, the plurality of reaction tube cavities 3 distributed in a circle, on one hand, are relatively compact in structure, and on the other hand, are more regular in layout, which facilitates operations of injecting and extracting test samples in the test. For example, eight, twelve or sixteen reaction tube cavities 3 are distributed in a circle around a same central axis in the same radius. An optional number of reaction tube cavities 3 may be eight, ten, twelve, sixteen or twenty-four. An optional material of the reaction tube cavities 3 may be polypropylene plastic.

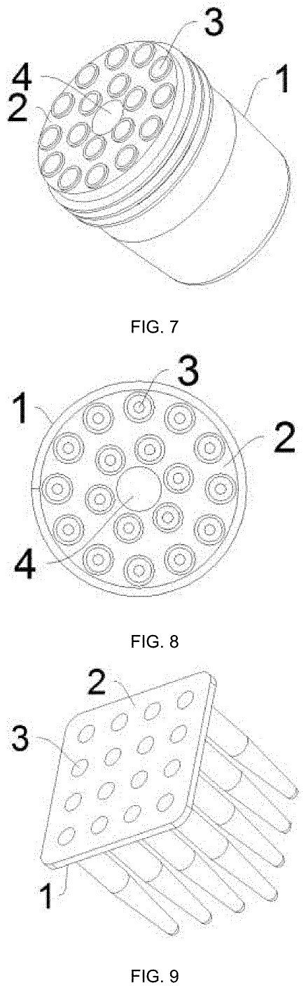

FIG. 7 is a perspective structural view of outline of a third reaction tube capable of performing multiple nucleic acid amplification provided in an example of the present disclosure; and FIG. 8 is a top view of FIG. 7. On the basis of the above example, as shown in FIGS. 7 and 8, further, the plurality of reaction tube cavities 3 are distributed in a circle in multiple different radii, wherein an optional number of different radii may be 2, 3 or 4. The reaction tube of this structure has a plurality of reaction tube cavities 3 distributed in a circle coaxially but in multiple different radii, then as many reaction tube cavities 3 as possible are provided in a smaller space, so that more samples can be detected simultaneously. For example, twelve reaction tube cavities 3 provided on an outer ring of a same radius R, and six reaction tube cavities 3 provided on an inner ring of a same radius r, which are uniformly arranged around the same central axis, where R>r. An optional material of the reaction tube cavities 3 may be polypropylene plastic.

On the basis of the above examples, as shown in FIGS. 1 and 2, further, the plurality of reaction tube cavities 3 located in the same ring are separately fixed to the base 1, respectively. In this structure, respective reaction tube cavities 3 provided independently save the material of the whole reaction tube, and reduce the weight of the reaction tube. Meanwhile, as being independently provided, the plurality of reaction tube cavities 3 are easily distinguished and arranged in appearance, facilitating the operation of the test and improving the detection efficiency.

Alternatively, as shown in FIGS. 4, 5, and 7, the plurality of reaction tube cavities 3 located in the same ring are integrally molded and fixed to the base 1. In this case, integrally molding all the reaction tube cavities 3 on the base 1 helps to uniformly heat all the reaction tube cavities 3 and achieve an isothermal effect, and the whole reaction tube is more compact in structure and more complete in appearance.

On the basis of the above examples, as shown in FIGS. 1, 3, 4, 6, 7, and 8, further, a central tube cavity 4 is also included; the central tube cavity 4 is provided on the reference plane 2 and is located at a ring center of the plurality of reaction tube cavities 3. In this structure, the central tube cavity 4 not only can reduce weight of a reaction tube body, but also can utilize the central tube cavity 4 as an operation space to perform an amplification reaction operation through an operation handle cooperating with the central tube cavity 4. The shape of the central tube cavity 4 is not limited, and an optional central tube cavity 4 may be a cylinder, a cuboid, a polyhedron or a cone.

On the basis of the above examples, as shown in FIGS. 1, 3, 7, and 8, further, the central tube cavity 4 penetrates through the base 1, further reducing the mass of the reaction tube, and also providing a sufficient space for the test operation.

On the basis of the above examples, the reaction tube capable of performing multiple nucleic acid amplification provided in the present disclosure further includes a blocking cover provided on the base 1, and the blocking cover can achieve unified blocking of all the reaction tube cavities 3. As shown in FIGS. 1-8, in one embodiment, a connector is provided on a side wall of the base 1, and the connector can be detachably connected to the blocking cover (not shown in the drawings). The connector has many forms, for example, the base 1 is provided with a resilient protrusion configured as the connector, and a groove is provided in the blocking cover, so as to realize the detachable connection between the connector and the blocking cover; alternatively, the base 1 is provided with a threaded structure configured as the connector, and a structure cooperating with the above threaded structure is provided in the blocking cover, so as to realize the detachable connection between the connector and the blocking cover. In another embodiment, the base 1 is provided with the connector, and the connector can be hinged with the blocking cover (not shown in the drawings).

Further, the base 1 is in a cylindrical shape, and an axis of the base coincides with an axis of the central tube cavity 4. In this structure, the base 1 in a cylindrical shape is convenient to be provided with a screw cover configured as the blocking cover, and by using a structure cooperating with a thread on a side wall of the screw cover, unified blocking of all the reaction tube cavities 3 by the screw cover is realized.

Based on the above examples, further, a blocking member (not labeled) or a screw cover (not labeled) is further included. In the above, the blocking member is provided at an opening of any reaction tube cavity 3, and the screw cover is spirally provided at one end of the base 1, blocking the openings of the plurality of reaction tube cavities 3. In this case, the blocking member may realize sealing of any single reaction tube cavity 3 with a heat sealing film or a heat sealant, and the screw cover blocks all the reaction tube cavities 3 integrally, temporarily seals the nucleic acid sample solution in the reaction tube cavities 3, prevents the nucleic acid sample solution against factors such as external dust and light, and may also prevent the nucleic acid sample solution from being poured out and flowing out. In addition, in order to facilitate injecting the nucleic acid sample solution, an injection hole may be provided in the screw cover.

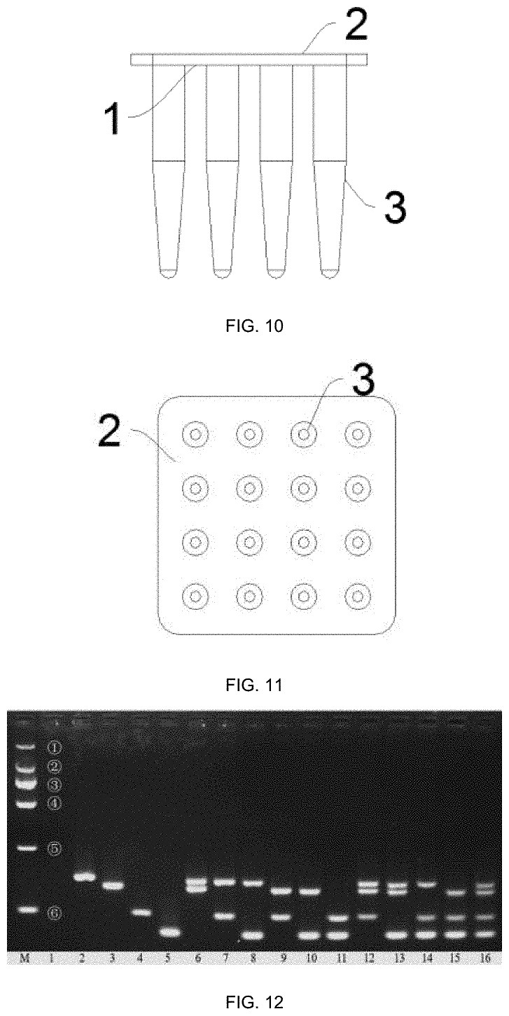

FIG. 9 is a perspective structural view of outline of a fourth reaction tube capable of performing multiple nucleic acid amplification provided in an example of the present disclosure; FIG. 10 is a front view of FIG. 9; and FIG. 11 is a top view of FIG. 10. On the basis of the above example, as shown in FIGS. 9-11, further, a plurality of reaction tube cavities 3 are distributed in rows and columns on the reference plane 2. The reaction tube cavities 3 distributed in rows and columns are more regular in structure and positioned more accurately.

Optionally, the plurality of reaction tube cavities 3 may be separately fixed to the base 1, respectively. Respective reaction tube cavities 3 provided independently save the material of the whole reaction tube, and reduce the weight of the reaction tube. Meanwhile, as being independently provided, the plurality of reaction tube cavities 3 are easily distinguished and arranged in appearance, facilitating the operation of the test and improving the detection efficiency.

Optionally, all the reaction tube cavities 3 may be integrally molded on the base 1. The respective reaction tube cavities 3 integrally molded help to uniformly heat all the reaction tube cavities 3 to achieve an isothermal effect, and the whole reaction tube is more compact in structure and more complete in appearance.

Optionally, a blocking cover provided on the base 1 is further included, and the blocking cover can achieve unified blocking of all the reaction tube cavities 3. In one embodiment, a connector is provided on a side wall of the base 1, and the connector can be detachably connected to the blocking cover (not shown in the drawings). The connector has many forms, for example, the base 1 is provided with a resilient protrusion configured as the connector, and a groove is provided in the blocking cover, so as to realize the detachable connection between the connector and the blocking cover; alternatively, the base 1 is provided with the connector, and the connector can be hinged with the blocking cover (not shown in the drawings).

Optionally, a blocking member (not labeled) is further included. In the above, the blocking member is provided at an opening of any reaction tube cavity 3, and the blocking cover is hinged at one end of the base 1 to block the openings of the plurality of reaction tube cavities 3. In this case, the blocking member may realize sealing of any single reaction tube cavity 3 with a heat sealing film or a heat sealant, and the blocking cover realizes integral blocking for all the reaction tube cavities 3, temporarily seals the nucleic acid sample solution in the reaction tube cavities 3, prevents the nucleic acid sample solution against factors such as external dust and light, and may also prevent the nucleic acid sample solution from being poured out and flowing out. In addition, in order to facilitate injecting the nucleic acid sample solution, an injection hole may be provided in the screw cover.

As shown in FIG. 1 and FIG. 2, the reaction tube capable of performing multiple nucleic acid amplification includes the base 1 and the plurality of reaction tube cavities 3 provided on the base 1; the base 1 is provided with a reference plane 2, the openings of the plurality of reaction tube cavities 3 are all provided on the reference plane 2, and the inner cavities of the plurality of reaction tube cavities all extend towards the interior of the base 1, perpendicularly to the reference plane 2. The plurality of reaction tube cavities 3 are distributed in a circle around the same axis in the same radius, and each is separately fixed to the base 1. In the above, the reaction tube cavity 3 includes a tube cavity main body and a tapered bottom connected to the tube cavity main body and narrowed from top to bottom. The reaction tube capable of performing multiple nucleic acid amplification further includes the central tube cavity 4 penetrating through the base 1; the central tube cavity 4 is provided on the reference plane 2 and is located at the ring center of the plurality of reaction tube cavities 3. The reaction tube capable of performing multiple nucleic acid amplification further includes the blocking cover (not labeled in the drawings) provided on the base 1. The base 1 is in a cylindrical shape, and the axis of the base coincides with the axis of the central tube cavity 4, the base 1 is provided with the threaded structure configured as the connector, and the structure cooperating with the above threaded structure is provided in the blocking cover, thereby uniformly blocking all the reaction tube cavities 3.

Hereinafter, illustration is made through multiple tube type PCR amplification test:

FIG. 12 is a chart of agarose gel electrophoresis result of integrated multiple tube type PCR amplification. As shown in FIG. 12, in the drawing,

M: \textcircled{1} DNA2000, 50 ng; \textcircled{2} DNA1000, 50 ng; \textcircled{3} DNA750, 150 ng; \textcircled{4} DNA500, 50 ng; \textcircled{5} DNA250, 50 ng; \textcircled{6} DNA100, 50 ng;

1: negative control of four wells;

2: electrophoresis result chart of integrated PCR tube type amplification of West Nile virus;

3: electrophoresis result chart of integrated PCR tube type amplification of eastern equine encephalitis virus;

4: electrophoresis result chart of integrated PCR tube type amplification of Venezuelan equine encephalitis virus;

5: electrophoresis result chart of integrated PCR tube type amplification of forest encephalitis virus;

6: electrophoresis result chart of 8-tube strip double amplification of West Nile virus and eastern equine encephalitis virus (from top to bottom of the strip);

7: electrophoresis result chart of 8-tube strip double amplification of West Nile virus and Venezuelan equine encephalitis virus (from top to bottom of the strip);

8: electrophoresis result chart of 8-tube strip double amplification of West Nile virus and forest encephalitis virus (from top to bottom of the strip);

9: electrophoresis result chart of 8-tube strip double amplification of eastern equine encephalitis virus and Venezuelan equine encephalitis virus (from top to bottom of the strip);

10: electrophoresis result chart of 8-tube strip double amplification of eastern equine encephalitis virus and forest encephalitis virus (from top to bottom of the strip);

11: electrophoresis result chart of 8-tube strip double amplification of Venezuelan equine encephalitis virus and forest encephalitis virus (from top to bottom of the strip);

12: electrophoresis result chart of 8-tube strip triple amplification of West Nile virus, eastern equine encephalitis virus, and Venezuelan equine encephalitis virus (from top to bottom of the strip);

13: electrophoresis result chart of 8-tube strip triple amplification of West Nile virus, eastern equine encephalitis virus, and forest encephalitis virus (from top to bottom of the strip);

14: electrophoresis result chart of 8-tube strip triple amplification of West Nile virus, Venezuelan equine encephalitis virus, and forest encephalitis virus (from top to bottom of the strip);

15: electrophoresis result chart of 8-tube strip triple amplification of eastern equine encephalitis virus, Venezuelan equine encephalitis virus, and forest encephalitis virus (from top to bottom of the strip);

16: electrophoresis result chart of 8-tube strip quadruple amplification of West Nile virus, eastern equine encephalitis virus, Venezuelan equine encephalitis virus, and forest encephalitis virus (from top to bottom of the strip)

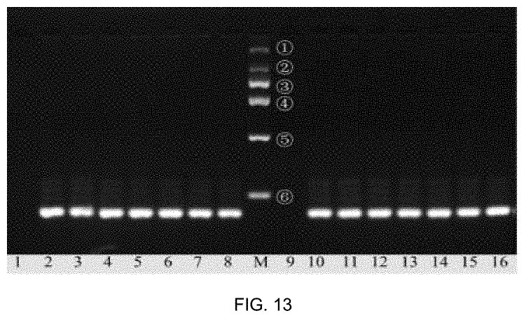

FIG. 13 is a chart of agarose gel electrophoresis result of integrated PCR amplification. As shown in FIG. 13, in the drawing,

M: \textcircled{1} DNA2000, 50 ng; \textcircled{2} DNA1000, 50 ng; \textcircled{3} DNA750, 150 ng; \textcircled{4} DNA500, 50 ng; \textcircled{5} DNA250, 50 ng; \textcircled{6} DNA100, 50 ng;

2-8: electrophoresis result chart of integrated tube type automatic sample-feeding PCR amplification of forest encephalitis virus;

9-16: electrophoresis result chart of integrated tube type manual sample-feeding PCR amplification of forest encephalitis virus;

1, 9: negative controls

### Example 1. Qualitative and Semi-Quantitative Detection of Integrated

tube type PCR amplification of four mosquito-borne viruses

1. Design of Specific Primers of Four Mosquito-Borne Viruses

The mosquito-borne viruses were selected as follows: West Nile virus, eastern equine encephalitis virus, Venezuelan equine encephalitis virus, and forest encephalitis virus, and specific primers were designed with their gene coding regions as amplification target regions. The sequences were seen in Table 1. Sequences of Specific Primers of Four Mosquito-borne Viruses.

TABLE 1
Sequences of Specific Primers of Four
Mosquito-borne Viruses

| Names | Sequences (5′-3′) |
|---|---|
| WNV-F | TGCTGATATGATTGATCC |
| WNV-R | TAGCGTAACACATCAGTG |
| EEE-F | ACACTAAATTCACCCTAGTTCGAT |
| EEE-R | GTGTATAAAATTACTTAGGAGCAGCATTATG |
| TBEV-F | GATCAAGTTCAGAGCGGGAATG |
| TBEV-R | CGATGTCACACATGATGGTATCAG |
| VEE-F | CTACCCAAAATGGAGAAAGTTC |
| VEE-R | GCTTGGCTTCTACCTCAAAC |

2. PCR System Formulation

(1) A quadruple PCR reaction system was formulated, including: a total reaction volume of the PCR reaction of 50 μL, 5×PCR buffer solution of 10 μL, 25×enzyme of 2 μL, upstream and downstream primers of West Nile virus, eastern equine encephalitis virus, Venezuelan equine encephalitis virus and forest encephalitis virus of each 0.3 μmol/L, template of 6 μL, and water for replenishment to a final volume of 50 μL;

(2) a triple PCR reaction system was formulated, 4 groups in total: \textcircled{1} group of West Nile virus, eastern equine encephalitis virus, and Venezuelan equine encephalitis virus; \textcircled{2} group of West Nile virus, eastern equine encephalitis virus, and forest encephalitis virus; \textcircled{3} group of West Nile virus, Venezuelan equine encephalitis virus, and forest encephalitis virus; and \textcircled{4} group of eastern equine encephalitis virus, Venezuelan equine encephalitis virus, and forest encephalitis virus, respectively, including: a total reaction volume of the PCR reaction of 25 μL, 5×PCR buffer solution of 5 μL, 25×enzyme of 1 μL, upstream and downstream primers each 0.3 μmol/L, template of 6 μL, and water for replenishment to a final volume of 25 μL;

(3) a double PCR reaction system was formulated, 6 groups in total: \textcircled{1} group of West Nile virus and eastern equine encephalitis virus; \textcircled{2} group of West Nile virus and Venezuelan equine encephalitis virus; \textcircled{3} group of West Nile virus and forest encephalitis virus; \textcircled{4} group of eastern equine encephalitis virus and Venezuelan equine encephalitis virus, \textcircled{5} group of eastern equine encephalitis virus and forest encephalitis virus, and \textcircled{6} group of Venezuelan equine encephalitis virus and forest encephalitis virus, respectively; including: a total reaction volume of the PCR reaction of 25 μL, 5×PCR buffer solution of 5 μL, 25×enzyme of 1 μL, upstream and downstream primers each 0.3 μmol/L, template of 6 μL, and water for replenishment to a final volume of 25 μL; and

(4) a single PCR reaction system was formulated, 4 groups in total: \textcircled{1} West Nile virus; \textcircled{2} eastern equine encephalitis virus; \textcircled{3} Venezuelan equine encephalitis virus; \textcircled{4} forest encephalitis virus, respectively; including: a total reaction volume of the PCR reaction of 15 μL, 5×PCR buffer solution of 3 μL, 25×enzyme of 0.6 μL, upstream and downstream primers each 0.3 μmol/L, template of 6 μL, and water for replenishment to a final volume of 15 μL.

3. PCR Amplification

### (1) Veriti® 96-Well Thermal Cycler PCR Instrument for Amplification

The Above Double, Triple, and Quadruple Systems were Respectively Added to an Axgen 8-tube strip PCR tube, and reaction condition was 50° C., 2 min; 94° C., 2 min; 94° C., 15 s, 58° C., 45 s, 35 cycles in total.

(2) Integrated Tube Type PCR Instrument Amplification

The above single system was added to a 8-well integrated tube from the top of the tube, wherein to well No. 1, well No. 3, well No. 5, and well No. 7 the single reaction systems of \textcircled{1} West Nile virus, \textcircled{2} eastern equine encephalitis virus, \textcircled{3} Venezuelan equine encephalitis virus, and \textcircled{4} forest encephalitis virus were added, respectively, and to well No. 2, well No. 4, well No. 6, and well No. 8 the negative control systems were added, and reaction condition was 50° C., 2 min; 94° C., 2 min; 94° C., 15 s, 58° C., 45 s, 35 cycles in total.

4. Qualitative and Semi-Quantitative Detection Result

Reference was made to CWBIO DM2000 DNA Marker for agarose gel electrophoresis experiment detection specification, and Tanon® Gel Image System ID analytical software was used. The effect of integrated tube type amplification of the four viruses was superior to triple, quadruple Axgen 8-tube strip PCR tube type reaction. The semi-quantitative results are as shown in Table 2. Table of Total Amounts of PCR Amplification Products of Different Amplification Systems, and qualitative results are as shown in FIG. 12.

TABLE 2
Table of Total Amounts of PCR Amplification
Products of Different Amplification Systems

| Ser. | Yield (ng) | | | |
|---|---|---|---|---|
| No. | 180 bp | 158 bp | 101 bp | 73 bp |
| 1 | —^{a} | — | — | — |
| 2 | 137 | | | |
| 3 | — | 125.07 | — | — |
| 4 | — | — | 89.68 | — |
| 5 | — | — | — | 122.8 |
| 6 | 123 | 115 | — | — |
| 7 | 106.7 | — | 83.28 | — |
| 8 | 85.39 | — | — | 114.69 |
| 9 | — | 96.11 | 80.28 | — |
| 10 | — | 89.28 | — | 115.17 |
| 11 | — | — | 81.54 | 115.17 |
| 12 | 79.36 | 81.44 | 41.43 | — |
| 13 | 75.22 | 74.13 | — | 114.69 |
| 14 | 69.3 | — | 42.72 | 114.69 |
| 15 | — | 71.58 | 39.96 | 110.22 |
| 16 | 52.52 | 47.69 | 28.86 | 84.93 |

^{a}No target product band was detected.

### Example 2. Qualitative and Semi-Quantitative Detection of Stability of Integrated Tube Type PCR Amplification

1. PCR System Formulation

A PCR reaction system was formulated, including, per well, a total reaction volume of the PCR reaction of 15 μL, 5×PCR buffer solution of 3 μL, 25×enzyme of 0.6 μL, upstream and downstream primers each 0.3 μmol/L, template of 6 μL, and water for replenishment to a final volume 15 μL.

2. PCR Amplification

The above formulation systems were respectively added to an 8-well integrated tube from the top of the tube, a negative control system was added to a well No. 1, and the forest encephalitis virus reaction system was added to wells Nos. 2-8.

Reaction condition was as follows: 50° C., 2 min; 94° C., 2 min; 94° C., 15 s, 58° C., 45 s, 35 cycles in total.

3. Qualitative and Semi-Quantitative Detection Result

Reference was made to CWBIO DM2000 DNA Marker for agarose gel electrophoresis experiment detection specification, and Tanon® Gel Image System ID analytical software was used. Results indicate that automatic sample addition and manual sample addition have relatively stable and uniform PCR amplification effects, and the effect of automatic sample addition is equivalent to that of the manual sample addition, and is relatively uniform and stable. The semi-quantitative results are as shown in Table 3. Chart of Agarose Gel Electrophoresis Result of Integrated PCR Amplification, and qualitative results are as shown in FIG. 13.

TABLE 3
Chart of Agarose Gel Electrophoresis Result
of Integrated PCR Amplification

| Serial | Yield |
|---|---|
| Number | (ng) |
| 1 | —^{a} |
| 2 | 240.74 |
| 3 | 215.43 |
| 4 | 240.12 |
| 5 | 242.47 |
| 6 | 245.06 |
| 7 | 216.67 |
| 8 | 204.12 |
| 9 | 207.41 |
| 10 | 216.67 |
| 11 | 219.75 |
| 12 | 211.73 |
| 13 | 222.84 |
| 14 | 223.7 |
| 15 | 224.69 |
| 16 | —^{a} |

^{a}No target product band was detected.

Finally, it should be explained that the various examples above are merely used for illustrating the technical solutions of the present disclosure, rather than limiting the present disclosure; although the detailed description is made to the present disclosure with reference to various preceding examples, those ordinarily skilled in the art should understand that they still could modify the technical solutions recited in various preceding examples, or make equivalent substitutions to some or all of the technical features therein; and these modifications or substitutions do not make the corresponding technical solutions essentially depart from the scope of the technical solutions of various examples of the present disclosure.

Besides, a person skilled in the art could understand that although some examples in the above include certain features included in other examples rather than other features, combinations of features in different examples means that they fall within the scope of the present disclosure and form different examples. For example, in the following claims, any of the examples claimed to protect can be used in any combination manner. Besides, information disclosed in the part of Background Art aims at deepening understanding to the overall background art of the present disclosure, but should not be regarded as acknowledging or implying in any form that the information constitutes prior art generally known by a person skilled in the art.

### INDUSTRIAL APPLICABILITY

To the reaction tube capable of performing multiple nucleic acid amplification provided in the present disclosure, a nucleic acid sample and various PCR systems can be added for performing multiple PCR amplification, or the tube cavities contain a PCR freeze-drying system, one kind of nucleic acid sample is allocated as required to different reaction tube cavities to realize amplification. It is also possible to amplify a plurality of different nucleic acids simultaneously, and retain or perform other reaction tests in the same reaction environment, thus greatly improving the nucleic acid amplification efficiency, and ensuring the uniformity of conditions for the nucleic acid amplification.

1. A reaction tube applicable to multiple nucleic acid amplification, comprising a base and a plurality of reaction tube cavities, wherein the base is provided with a reference plane; openings of the plurality of reaction tube cavities are all provided on the reference plane, and inner cavities of the plurality of reaction tube cavities all extend, perpendicularly to the reference plane, towards an interior of the base.

2. The reaction tube applicable to multiple nucleic acid amplification according to claim 1, wherein the plurality of reaction tube cavities are arranged in a circle around a same axis.

3. The reaction tube applicable to multiple nucleic acid amplification according to claim 2, wherein the plurality of reaction tube cavities are arranged around a same axis, to form one circle with same radius.

4. The reaction tube applicable to multiple nucleic acid amplification according to claim 2, wherein the plurality of reaction tube cavities are arranged around a same axis to form multiple circles having different radii.

5. The reaction tube applicable to multiple nucleic acid amplification according to claim 3, wherein the plurality of reaction tube cavities located in a same circle are separately fixed to the base, respectively.

6. The reaction tube applicable to multiple nucleic acid amplification according to claim 3, wherein the plurality of reaction tube cavities located in a same circle are integrally molded and fixed to the base.

7. The reaction tube applicable to multiple nucleic acid amplification according to claim 1, wherein each of the reaction tube cavities comprises a tube cavity main body and a tapered bottom connected to the tube cavity main body and narrowed from top to bottom.

8. The reaction tube applicable to multiple nucleic acid amplification according to claim 1, wherein a material of the reaction tube cavities comprises polypropylene plastic.

9. The reaction tube applicable to multiple nucleic acid amplification according to claim 1, further comprising a central tube cavity, wherein the central tube cavity is provided on the reference plane and is located at a circle center of the plurality of reaction tube cavities.

10. The reaction tube applicable to multiple nucleic acid amplification according to claim 9, wherein the central tube cavity penetrates through the base.

11. The reaction tube applicable to multiple nucleic acid amplification according to claim 10, wherein the base is in a cylindrical shape, and an axis of the base coincides with an axis of the central tube cavity.

12. The reaction tube applicable to multiple nucleic acid amplification according to claim 1, further comprising a blocking cover provided on the base, wherein the blocking cover is configured to block the openings of the reaction tube cavities.

13. The reaction tube applicable to multiple nucleic acid amplification according to claim 12, wherein the blocking cover further comprises an injection hole, wherein the injection hole is configured to inject a reaction solution into the reaction tube cavities.

14. The reaction tube applicable to multiple nucleic acid amplification according to claim 12, wherein the blocking cover is detachably connected to the base.

15. The reaction tube applicable to multiple nucleic acid amplification according to claim 12, wherein the blocking cover is hinged with the base.

16. The reaction tube applicable to multiple nucleic acid amplification according to claim 1, further comprising a blocking member provided at an opening of a reaction tube cavity.

17. The reaction tube applicable to multiple nucleic acid amplification according to claim 16, wherein the blocking member is a heat sealing film or a heat sealant.

18. The reaction tube applicable to multiple nucleic acid amplification according to claim 1, wherein the blocking member is provided at an opening of any one of the reaction tube cavities; and
a screw cover is spirally provided at one end of the base and configured to block the openings of the plurality of reaction tube cavities.

19. The reaction tube applicable to multiple nucleic acid amplification according to claim 1, wherein the plurality of reaction tube cavities are arranged in rows and columns on the reference plane.

20. The reaction tube applicable to multiple nucleic acid amplification according to claim 4, wherein the plurality of reaction tube cavities located in a same circle are separately fixed to the base, respectively.
